(19) United States
(12) Patent Application Publication
(10) Pub. No.: US 2026/0244581 A1
(43) Pub. Date: Aug. 20, 2026

(54) Memory-Centric Communication Operating Architecture with Unified System Domain and Admissibility-Governed Communication Constitution

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/641,381

(22) Filed: Apr. 7, 2026

(51) Int. Cl. G06F 13/16

(52) U.S. Cl. CPC G06F 13/16; G06F 2213/16

(57) ABSTRACT

A distributed communication system operates according to a memory-centric operating architecture in which communication behavior is structurally constituted within a unified operating layer through admissibility relationships among continuity-preserved memory representations. The system comprises a processing unit, system memory, communication bearers, and distributed nodes operating across heterogeneous communication bearers spanning multiple physical communication carriers. Communication bearers provide communication capability without defining communication behavior. The unified operating layer defines an admissibility-governed decision space in which communication behavior is constituted independent of routing protocols, protocol selection mechanisms, or predefined workflows. Distributed nodes participate within a unified system domain under admissibility-governed relationships.

### CROSS-REFERENCE TO RELATED APPLICATIONS

This application relates to communication system architectures and distributed communication systems configured to operate across heterogeneous communication environments. The disclosure relates to systems in which communication behavior is structurally constituted within a unified operating layer through admissibility relationships among continuity-preserved memory representations, rather than being determined by routing protocols, protocol selection mechanisms, or predefined communication workflows. The disclosure further relates to communication systems in which communication behavior is constituted within a unified system domain.

### PRIOR ART

The following patents and published patent applications have been identified as publicly accessible references and are submitted in compliance with Information Disclosure Statement (IDS) requirements.

Inclusion of any reference does not constitute an admission regarding the relevance of any reference to the patentability of the present disclosure.

The cited references generally relate to technological domains including wireless mesh networking, distributed communication systems, routing architectures, multi-radio coordination systems, software-defined networking, network orchestration systems, edge communication infrastructures, distributed memory systems, and artificial intelligence-assisted communication systems.

These references illustrate neighboring technological domains involving routing-based communication control, protocol-driven network coordination, software-defined control planes, distributed data transmission systems, communication optimization frameworks, and machine learning-based network decision systems.

The cited references are provided to assist the patent office in evaluating the technological environment surrounding the present disclosure.

The present disclosure structurally differs from the cited references in several fundamental aspects.

Conventional systems represented by the cited references generally determine communication behavior through routing mechanisms, protocol-defined control structures, software-defined networking control planes, orchestration frameworks, or performance optimization strategies. Communication decisions in such systems are typically governed within communication domains, control planes, or policy-driven frameworks and are dependent on communication modality, network topology, or protocol constraints.

In such conventional systems, communication actions are frequently determined by routing metrics, shortest-path selection, load balancing strategies, policy-based control, or protocol-defined decision rules. Even in software-defined or intent-based systems, communication behavior remains derived from control logic or policy evaluation within defined network layers.

In contrast, the present disclosure introduces a memory-centric communication operating architecture in which communication behavior is constituted within a unified system domain through admissibility relationships among continuity-preserved memory representations, independent of routing mechanisms, protocol-defined control structures, or control-plane-driven decision frameworks.

Communication behavior in the present disclosure is not derived from routing computation, protocol arbitration, policy evaluation, or optimization logic. Instead, communication behavior corresponds to admissibility relationships within a unified operating layer, wherein continuity-preserved memory representations remain structurally relevant across system states.

The cited references, individually or in combination, do not disclose or suggest an architecture in which communication behavior is constituted through admissibility relationships within a unified system domain independent of communication modality, routing structures, or control-plane logic.

The cited references do not disclose or suggest a system in which heterogeneous communication bearers are treated as structurally interchangeable participation resources that do not define system behavior.

The cited references do not disclose or suggest a communication architecture in which continuity-preserved memory representations participate as structural determinants of communication behavior across system states.

The cited references do not disclose or suggest an architecture in which communication behavior is constituted independently of routing, protocol selection, policy evaluation, or software-defined control-plane mechanisms.

Furthermore, the cited references do not disclose or suggest integration of artificial intelligence systems as subordinate candidate-generating entities whose outputs are structurally incorporated without constituting independent communication authority.

The combination of unified system domain constitution, admissibility-governed participation, modality-independent communication structuring, and memory-based structural continuity defines an architecture that is not reducible to conventional routing systems, protocol-driven frameworks, software-defined networking systems, or machine learning-based optimization systems.

### US PATENT DOCUMENTS

U.S. Pat. No. 8,249,042 B2 08/2012 Sparr et al.
US 2005/0201340 A1 09/2005 Wang et al.
U.S. Pat. No. 8,787,330 B2 07/2014 Goel et al.
U.S. Pat. No. 7,957,737 B2 06/2011 Lee
U.S. Pat. No. 7,336,642 B2 02/2008 Rich et al.
U.S. Pat. No. 10,383,069 B2 08/2019 Nguyen-Dang
U.S. Pat. No. 11,265,799 B2 03/2022 Tao et al.
U.S. Pat. No. 8,189,577 B2 05/2012 Vaswani et al.
U.S. Pat. No. 8,675,578 B2 03/2014 Kim et al.
U.S. Pat. No. 10,721,162 B2 07/2020 Jagannath et al.
U.S. Pat. No. 10,305,803 B2 05/2019 Fredette et al.
U.S. Pat. No. 11,082,525 B2 08/2021 Sethuraman et al.
U.S. Pat. No. 10,379,842 B2 08/2019 Malladi et al.
U.S. Pat. No. 9,826,571 B2 11/2017 Iyer et al.

### BACKGROUND OF THE INVENTION

Conventional communication systems are typically implemented using routing-based architectures, protocol-driven communication stacks, or infrastructure-dependent communication frameworks. In such systems, communication behavior is determined through route computation, link evaluation, signal strength measurement, or protocol selection logic. These systems often rely on sequential evaluation of communication options, dynamic routing updates, or protocol arbitration processes that operate on instantaneous communication conditions.

In heterogeneous communication environments, including environments that combine mesh communication, point-to-point communication, infrastructure-based communication, and long-range communication, such conventional approaches exhibit limitations. Routing-based systems tend to prioritize shortest paths or strongest signals, which may not reflect communication continuity across system states. Protocol-driven systems rely on predefined communication stacks that may not adapt coherently across mixed communication bearers. Infrastructure-dependent systems may degrade significantly when infrastructure is partially unavailable or dynamically changing.

In distributed systems involving heterogeneous nodes, including autonomous systems, mobile units, sensors, and infrastructure nodes, communication behavior may become fragmented when different nodes rely on different communication mechanisms. Node-level decisions based on local routing or protocol logic may not align with system-level communication continuity. Additionally, artificial intelligence-based approaches that generate communication decisions may introduce inconsistency when such decisions are not structurally integrated with system-wide communication conditions.

These limitations indicate that existing communication systems lack a unified structural framework capable of constituting communication behavior across heterogeneous communication bearers, heterogeneous node capabilities, and dynamic operational environments while maintaining continuity across system states. Accordingly, there exists a need for a communication architecture in which communication behavior is constituted within a unified structural domain based on continuity-preserved memory rather than routing or protocol-based determination.

### SUMMARY OF THE INVENTION

The present disclosure provides a distributed communication system configured to operate according to a memory-centric operating architecture. In such architecture, communication behavior is structurally constituted within a unified operating layer through admissibility relationships among continuity-preserved memory representations. The system comprises at least one processing unit, at least one system memory, one or more communication bearers, and a plurality of distributed nodes. The unified operating layer defines an admissibility-governed decision space within which communication behavior is constituted.

The system memory maintains continuity-preserved memory representations corresponding to prior communication continuity, environmental conditions, node participation consistency, and system-level communication context. Communication behavior corresponds to admissibility relationships among such memory representations rather than being determined by routing protocols, protocol selection mechanisms, or signal-based evaluation.

Communication bearers comprise mesh-based and non-mesh communication structures spanning multiple physical communication carriers including wired, optical, wireless, and additional communication carriers. These communication bearers provide communication capability substrates but do not define communication behavior. Distributed nodes, including heterogeneous nodes with differing communication and memory capabilities, are structurally contained within a unified system domain and participate under admissibility-governed relationships.

Artificial intelligence components may be structurally associated with candidate-generating participation but do not independently define communication behavior. Communication behavior is constituted exclusively within the unified system domain, which remains the sole structural domain across all embodiments.

### BRIEF DESCRIPTION OF DRAWINGS

FIG. 1—Overall Constitutional System Structure

FIG. 2—Heterogeneous Communication Bearer Structure

FIG. 3—Physical Communication Carrier Structure

FIG. 4—Unified Communication Decision Space Structure

FIG. 5—Memory Participation Structure

FIG. 6—Distributed Node Participation Structure

FIG. 7—Multi-Regime Communication Structure

FIG. 8—Capability-Differentiated Node Participation Structure

### DETAILED DESCRIPTION OF THE INVENTION

The figures define expressive constitutional structural representations of a memory-centric communication operating architecture. The illustrated structures express containment, participation, admissibility relationships, and structural positioning without implying execution sequence, routing flow, protocol selection order, or temporal progression.

All elements identified by reference numerals constitute inseparable components of a unified operating architecture and cannot independently determine or override communication behavior under any structural configuration. Communication bearers, communication carriers, mesh-based resources, non-mesh resources, artificial intelligence components, distributed nodes, and external resources are structurally subordinate to a unified communication decision space and do not independently define system behavior.

Communication behavior is constituted exclusively within a unified system domain through admissibility relationships among continuity-preserved memory representations. The unified system domain defines a sole structural domain within which the unified operating layer, system memory, communication bearers, distributed nodes, and external resources associated with system operation are structurally contained and participate under admissibility-governed determination. No structural configuration permits reallocation of communication behavior constitution outside the unified system domain.

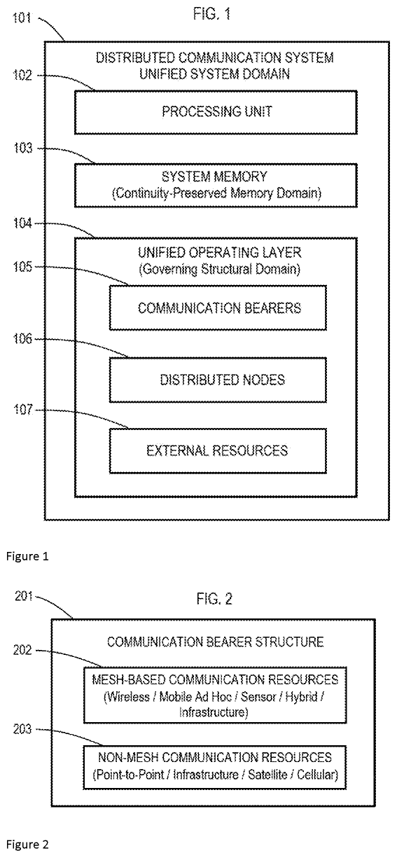

FIG. 1 illustrates a distributed communication system (101) that defines a unified system domain within which a processing unit (102), a system memory (103), a unified operating layer (104), communication bearers (105), distributed nodes (106), and external resources (107) are structurally contained. The unified operating layer (104) defines a governing structural domain within the system (101). The system memory (103) is structurally positioned as a continuity-preserved memory domain. The communication bearers (105), distributed nodes (106), and external resources (107) are structurally positioned as subordinate domains within the unified operating layer (104). All elements are structurally contained within the unified system domain and are prevented from independently defining communication behavior.

FIG. 2 illustrates a communication bearer structure (201) that defines a domain of heterogeneous communication bearers within which mesh-based communication resources (202) and non-mesh communication resources (203) are structurally contained. The mesh-based communication resources (202) encompass wireless mesh, mobile ad hoc mesh, sensor mesh, hybrid mesh, and infrastructure-assisted mesh communication forms. The non-mesh communication resources (203) encompass point-to-point communication, infrastructure-based communication, satellite communication, and cellular communication structures. Both (202) and (203) are structurally contained within the communication bearer structure (201) as communication resources without defining communication behavior.

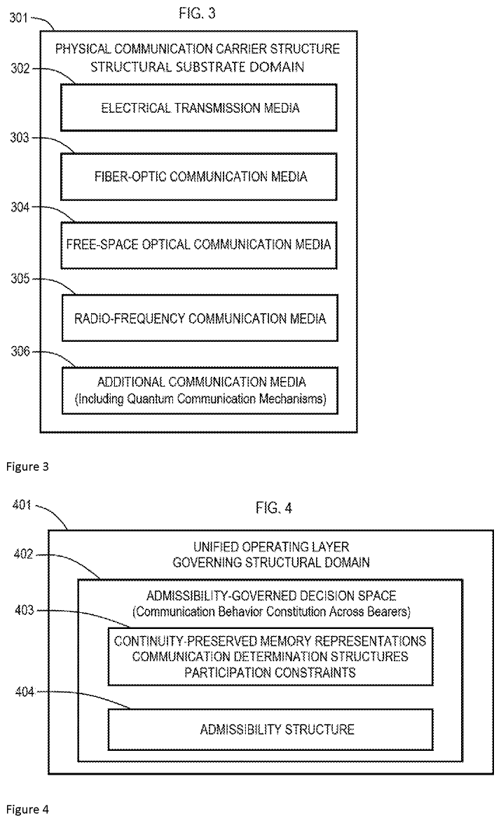

FIG. 3 illustrates a physical communication carrier structure (301) that defines a substrate domain upon which communication bearers are structurally realized, within which electrical transmission media (302), fiber-optic communication media (303), free-space optical communication media (304), radio-frequency communication media (305), and additional communication media including quantum communication mechanisms (306) are structurally contained. The physical communication carrier structure (301) defines a structural substrate and does not define communication behavior.

FIG. 4 illustrates a unified operating layer (401) that defines a governing structural domain and includes an admissibility-governed decision space (402). The admissibility-governed decision space (402) defines a central structural domain within which communication behavior is constituted across heterogeneous communication bearers. Structural conditions (403) comprising continuity-preserved memory representations, communication determination structures defined within the unified operating layer and structurally associated with the admissibility-governed decision space, and participation constraints are structurally associated with the admissibility-governed decision space (402). An admissibility structure (404) is positioned within the admissibility-governed decision space (402) and defines admissibility relationships. Communication behavior is structurally constituted within the admissibility-governed decision space (402) and is not defined by any communication bearer, routing mechanism, protocol, or workflow structure.

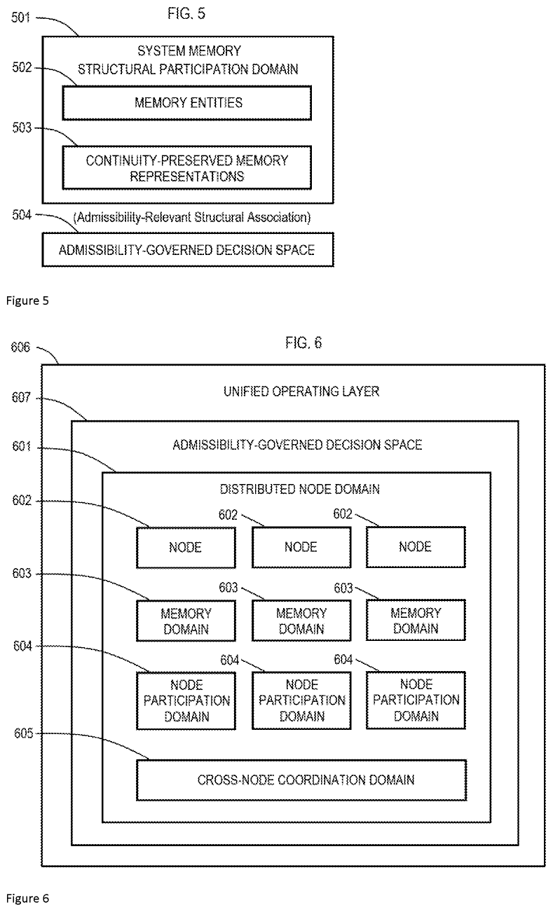

FIG. 5 illustrates a system memory (501) that defines a structural participation domain within which memory entities (502) and continuity-preserved memory representations (503) are structurally contained. The continuity-preserved memory representations (503) are structurally associated with an admissibility-governed decision space (504) through an admissibility-relevant structural association, the association being explicitly defined as a structural relationship without implying directional execution, procedural flow, or algorithmic behavior. The system memory (501) constitutes an operational participation domain structurally integrated into communication behavior constitution.

FIG. 6 illustrates a distributed node domain (601) that comprises a plurality of distributed nodes (602) structurally contained within the unified system domain, wherein plurality is represented without differentiation of identifier suffix and corresponds to multiple structurally equivalent nodes. Each distributed node (602) comprises a node memory domain (603) and a node participation domain (604). A cross-node coordination domain (605) is structurally associated with the plurality of distributed nodes (602) as a cross-node structural domain, the association being defined as spanning across nodes rather than being contained within a single node or within the node domain as an internal component. The cross-node coordination domain (605) is further structurally associated with an admissibility-governed decision space (607), through which node-level memory entities participate in admissibility determination. The distributed nodes (602) are structurally constrained within the unified operating layer (606) and the admissibility-governed decision space (607) without independently defining communication behavior.

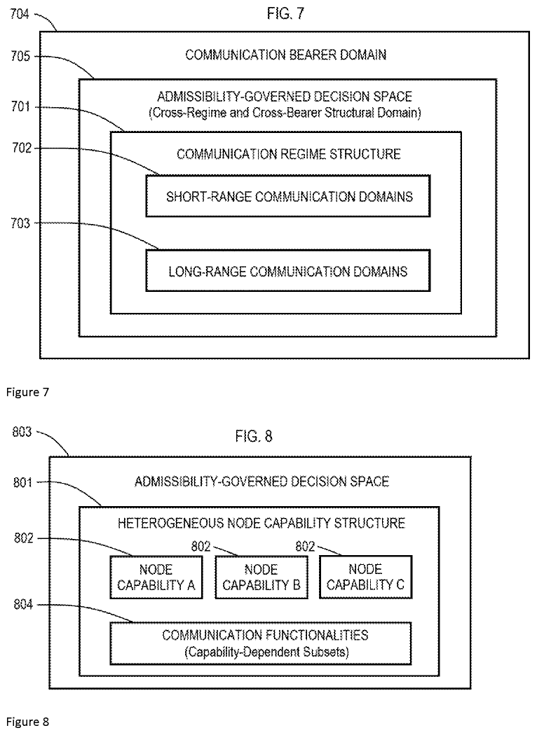

FIG. 7 illustrates a communication regime structure (701) that defines multiple communication regimes including short-range communication domains (702) and long-range communication domains (703), the regimes being structurally differentiated by communication characteristics including transmission range, capacity, and communication conditions. The communication regime structure (701) is structurally contained within a communication bearer domain (704). An admissibility-governed decision space (705) is structurally associated across the communication regime structure (701) as a cross-regime structural domain, the association being defined as spanning across the plurality of communication regimes (702, 703) and independent of regime-specific characteristics. Communication behavior is further constituted across heterogeneous communication bearers independent of bearer-specific characteristics within the admissibility-governed decision space (705), without dependence on any individual regime structure.

FIG. 8 illustrates a heterogeneous node capability structure (801) that comprises a plurality of distributed nodes (802) having differing capability profiles, plurality being represented without identifier differentiation and corresponding to multiple nodes within the system. Each node (802) is structurally associated with a subset of communication functionalities (804), the communication functionalities (804) corresponding to capability-dependent subsets. The plurality of distributed nodes (802) are structurally positioned within an admissibility-governed decision space (803), the positioning being defined as a structural situating relationship independent of node-specific execution conditions. The admissibility-governed decision space (803) structurally maintains consistency of communication behavior across the plurality of distributed nodes (802) irrespective of capability differences.

The structures described herein define a memory-centric communication operating architecture in which communication behavior is structurally constituted within a unified operating layer through admissibility relationships among continuity-preserved memory representations. The described architecture does not impose execution sequence, routing sequence, protocol selection order, temporal ordering, or algorithmic workflow. All expressions of system behavior correspond to structural admissibility relationships rather than procedural execution logic.

All system elements, including the unified operating layer, system memory, communication bearers, distributed nodes, and external resources associated with system operation, are structurally contained within a unified system domain. No communication bearer, routing mechanism, protocol mechanism, node, or artificial intelligence component independently defines communication behavior. Communication behavior is constituted exclusively within the unified system domain as a structural condition.

In one architectural interpretation, a distributed communication system comprises at least one processing unit, at least one system memory, one or more communication bearers, and a plurality of distributed nodes. The unified operating layer executed by the processing unit defines a structural domain within which communication behavior is constituted through admissibility relationships among continuity-preserved memory representations.

The communication bearers include mesh-based communication structures and non-mesh communication structures spanning multiple physical communication carriers including wired, optical, wireless, and additional communication carriers. These communication carriers provide structural communication substrates and do not define communication behavior. Communication behavior is not reducible to bearer selection, route selection, or protocol selection under any structural interpretation of the architecture.

The unified system domain structurally contains the unified operating layer, the system memory, the communication bearers, the distributed nodes, and external resources associated with system operation. The unified system domain remains the sole structural domain within which communication behavior is constituted.

The system memory constitutes a structural participation domain in which continuity-preserved memory representations are maintained. These memory representations correspond to prior communication continuity, prior communication disruption conditions, environmental continuity, platform continuity, node participation consistency, and system-level communication context.

Continuity-preserved memory representations remain structurally relevant across system states. Communication behavior is constituted through admissibility relationships among such representations, wherein prior system conditions remain structurally consistent with present communication constitution without requiring sequential evaluation.

The system memory is structurally integrated into communication constitution. Communication behavior corresponds to continuity-preserved structural relationships rather than transient signal conditions alone.

Distributed nodes are structurally contained within the unified system domain. Each distributed node defines a node participation domain and, in some implementations, a node memory domain. Node memory domains correspond to node-local continuity-preserved memory entities associated with communication continuity, environmental interaction, and platform conditions.

Node-level memory entities are structurally associated with system-level memory through a cross-node coordination domain. Communication behavior corresponds to admissibility relationships that incorporate both node-level and system-level memory representations.

Nodes may differ in communication capability, memory capability, and processing capability. Such differences remain structurally consistent with unified system participation and do not result in independent communication behavior definition.

Communication behavior is not determined by routing protocols, predefined workflows, protocol selection mechanisms, or alternative communication control mechanisms. Communication behavior is structurally constituted through admissibility relationships among continuity-preserved memory representations.

Communication bearers provide communication capability substrates. Communication behavior corresponds to structural admissibility relationships and is not reducible to signal strength, routing path, or protocol selection under any structural interpretation.

Artificial intelligence components are structurally associated with candidate-generating participation. Candidate communication structures, candidate participation relationships, and candidate communication states are structurally incorporated within the unified operating layer.

Artificial intelligence components do not define communication behavior. No structural configuration permits artificial intelligence components to assume independent communication determination authority outside the unified operating layer.

In one implementation involving a UAV swarm with multi-layer communication, a plurality of aerial nodes are structurally contained within a unified system domain. Certain nodes are structurally associated with short-range mesh communication participation, while other nodes are structurally associated with long-range radio-frequency communication participation. Continuity-preserved memory representations correspond to prior relay stability, altitude-dependent communication continuity, and prior swarm configuration conditions. Communication behavior is structurally constituted wherein relay participation remains admissible in correspondence with continuity-preserved memory relevance. Communication behavior corresponds to structural continuity rather than shortest-path routing or instantaneous signal selection.

In one implementation involving a distributed swarm with heterogeneous node capabilities, certain nodes define node memory domains while other nodes define limited participation domains. System-level memory maintains continuity-preserved representations corresponding to swarm-level communication continuity. Communication behavior is structurally constituted wherein node participation remains consistent with system-level admissibility relationships regardless of node capability differences. Communication behavior corresponds to system-level continuity rather than node-level independence.

In one implementation involving a mobile vehicle convoy operating across variable terrain, continuity-preserved memory representations correspond to prior communication disruption zones, terrain-dependent signal behavior, and convoy geometry conditions. Communication behavior is structurally constituted wherein convoy communication continuity remains consistent with such representations. Communication behavior corresponds to structural continuity rather than nearest-neighbor routing or instantaneous signal evaluation.

In one implementation involving an industrial environment with mixed wired and wireless communication systems, continuity-preserved memory representations correspond to interference zones, machine operational states, and communication continuity conditions. Communication behavior is structurally constituted wherein communication participation remains consistent with structural continuity across machine states. Communication behavior corresponds to operational continuity rather than transient signal preference.

In one implementation involving disaster response with partial infrastructure availability, continuity-preserved memory representations correspond to prior communication stability, disruption zones, and operational priority conditions. Communication behavior is structurally constituted wherein essential communication participation remains admissible across distributed nodes. Communication behavior corresponds to continuity-preserved admissibility rather than temporary link capacity.

In one implementation involving hybrid long-range and short-range communication, communication bearers include both mesh-based communication structures and long-range radio-frequency structures. Continuity-preserved memory representations correspond to communication continuity across both regimes. Communication behavior is structurally constituted wherein long-range communication participation and short-range participation remain structurally consistent within a unified system domain. Communication behavior corresponds to admissibility relationships rather than bearer dominance.

In one implementation involving artificial intelligence-assisted communication, artificial intelligence components produce candidate communication structures. These candidate structures are structurally incorporated within the unified operating layer. Communication behavior is structurally constituted wherein candidate structures remain subordinate to admissibility relationships. Communication behavior corresponds to system-defined admissibility rather than model-generated outputs.

In one implementation involving node memory coordination, node-level memory entities correspond to local communication continuity and are structurally associated with system-level memory representations. Communication behavior is structurally constituted wherein local and global continuity remain structurally integrated. Communication behavior corresponds to unified admissibility relationships rather than isolated node behavior.

In one implementation involving non-sequential communication constitution, communication behavior is structurally constituted without reliance on execution sequence, routing sequence, or temporal ordering. Communication behavior corresponds to structural admissibility conditions existing within the unified system domain.

In one implementation involving multiple coexisting communication subsystems, communication bearers, and node classes, all elements are structurally contained within a unified system domain. Communication behavior is structurally constituted wherein all participation remains consistent with a sole structural domain. Communication behavior is not reducible to route computation, link evaluation, or protocol arbitration under any structural interpretation of the architecture.

The disclosed architecture defines a communication operating system in which communication behavior is structurally constituted within a unified operating layer through admissibility relationships among continuity-preserved memory representations. System memory provides structural continuity. Distributed nodes participate within unified structural domains. Communication bearers provide capability without defining behavior. Artificial intelligence participates without authority.

Communication behavior corresponds to structural admissibility relationships and is not reducible to routing, protocol selection, or execution sequence. The unified system domain remains the sole structural domain within which communication behavior is constituted across all embodiments.

The disclosed structure corresponds to a communication system architecture in which communication behavior is constituted through structural admissibility relationships across heterogeneous communication bearers and distributed node memory domains, rather than through routing tables, protocol stacks, or forwarding mechanisms.

1. A distributed communication system configured to operate according to a memory-centric operating architecture, the system comprising:
at least one processing unit;
at least one system memory;
one or more communication bearers; and
a plurality of distributed nodes;
wherein the system is configured to operate across heterogeneous communication bearers comprising mesh-based and non-mesh communication resources spanning multiple physical communication carriers including wired, optical, wireless, and additional communication carriers;
wherein the system further comprises a unified operating layer executed by the at least one processing unit;
wherein the system memory is configured to store continuity-preserved memory representations;
wherein the unified operating layer is configured to constitute communication behavior through admissibility determination based on the continuity-preserved memory representations;
wherein communication behavior is constituted within the unified operating layer independent of any individual communication bearer, routing mechanism, or protocol-specific decision process; and
wherein the system defines a unified system domain as a sole structural domain within which the unified operating layer, the system memory, the communication bearers, the plurality of distributed nodes, and external resources associated with system operation are structurally contained and participate under admissibility-governed determination.

2. The system of claim 1, wherein the heterogeneous communication bearers comprise one or more mesh communication structures selected from wireless mesh, mobile ad hoc mesh, sensor mesh, hybrid mesh, or infrastructure-assisted mesh communication forms.

3. The system of claim 1, wherein the heterogeneous communication bearers further comprise non-mesh communication structures including point-to-point communication, infrastructure-based communication, satellite communication, or cellular communication.

4. The system of claim 1, wherein the physical communication carriers comprise electrical transmission media, fiber-optic communication media, free-space optical communication media, radio-frequency communication media, or future communication media including quantum communication mechanisms.

5. The system of claim 1, wherein the unified operating layer defines an operating layer domain that includes an admissibility-governed decision space within which communication behavior is constituted.

6. The system of claim 5, wherein the admissibility-governed decision space comprises structural conditions including memory representations, communication determination structures structurally defined within the unified operating layer and associated with the admissibility-governed decision space, and participation constraints.

7. The system of claim 1, wherein the system memory constitutes a structural participation domain in which memory entities are maintained and made available for admissibility determination.

8. The system of claim 1, wherein the plurality of distributed nodes each comprise a node memory domain and a node participation domain.

9. The system of claim 8, wherein the plurality of distributed nodes further comprise a cross-node coordination domain through which node-level memory entities participate in system-level admissibility determination.

10. The system of claim 1, wherein artificial intelligence components participate as candidate-generating entities without constituting execution authority within the unified operating layer.

11. The system of claim 1, wherein communication behavior is not determined by routing protocols, predefined workflows, protocol selection mechanisms, or alternative communication control mechanisms, but is constituted within the unified operating layer through admissibility-governed determination.

12. The system of claim 1, wherein the unified system domain comprises a plurality of structurally bounded domains including a system domain, an operating layer domain, and a communication bearer domain.

13. A method for operating a distributed communication system according to a memory-centric operating architecture, wherein the method is performed by at least one processing unit in association with a system memory and a plurality of distributed nodes, the method comprising:
maintaining continuity-preserved memory representations in the system memory;
constituting communication behavior within a unified operating layer through admissibility determination based on the continuity-preserved memory representations;
constituting communication behavior independent of any individual communication bearer, routing mechanism, or protocol-specific decision process; and
wherein the method is performed within a unified system domain that structurally contains a unified operating layer, communication bearers, distributed nodes, and external resources associated with system operation under admissibility-governed participation.

14. The method of claim 13, wherein the admissibility determination is performed within an admissibility-governed decision space defined in an operating layer domain.

15. The method of claim 13, wherein communication behavior is constituted across heterogeneous communication bearers without reliance on routing protocols or protocol selection mechanisms.

16. The method of claim 13, wherein distributed nodes contribute node-level memory entities participating in system-level admissibility determination.

17. The method of claim 13, wherein communication behavior is constituted without reliance on execution sequence, routing sequence, protocol selection sequence, or temporal ordering.

18. The method of claim 13, wherein external resources comprise mission inputs, operator inputs, environmental conditions, or platform conditions associated with system operation.

19. A non-transitory computer-readable medium storing instructions that, when executed by at least one processing unit of a distributed communication system configured to operate according to a memory-centric operating architecture, cause the at least one processing unit to:
maintain continuity-preserved memory representations;
constitute communication behavior within a unified operating layer through admissibility determination based on the continuity-preserved memory representations;
constitute communication behavior independent of any individual communication bearer, routing mechanism, or protocol-specific decision process; and
establish a unified system domain as a sole structural domain within which system elements are structurally contained and participate under admissibility-governed conditions.

20. The non-transitory computer-readable medium of claim 19, wherein communication behavior is constituted across heterogeneous communication bearers and incorporates node-level memory entities participating in system-level admissibility determination.
